(19) United States
(12) Patent Application Publication
(10) Pub. No.: US 2008/0056230 A1
(43) Pub. Date: Mar. 6, 2008

(54) Opportunistic channel unblocking mechanism for ordered channels in a point-to-point interconnect

(76) Inventors: Geeyarpuram N. Santhanakrishnan, Hillsboro, OR (US); Georg Cai, Lake Oswego, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/512,878

(22) Filed: Aug. 29, 2006

(51) Int. Cl. H04L 12/28; H04L 12/56

(52) U.S. Cl. 370/351; 370/412

(57) ABSTRACT

A system and method of opportunistically unblocking channels in an ordered channel architecture. Masking logic creates masking parameters based on partial addresses received with a message. A subsequent message is imparted with the masking parameters to determine if it should be blocked. Based on the result of the comparison, the message is placed in either a blocked buffer or an unblocked buffer so that messages in the unblocked buffer may make progress independent of the message in the blocked buffer.

### BACKGROUND

1. Field

Embodiments of the invention relate to message ordering. More specifically, embodiments of the invention relate to opportunistic unblocking of messages on ordered channels.

2. Background

In systems with multiple caching agents, if the caching agents are connected by a point-to-point link, such as common system interconnect (CSI), maintaining cache coherency generally requires a particular ordering of messages to avoid data error. For example, it is important that if a caching agent sends request A followed by request B, the request A be received and processed by the home agent before request B. This ordering mechanism is limited to a particular address. Accordingly, if request A is to address A and request B is to address B, they may proceed in any order.

However, it is commonly the case with certain point-to-point interconnect architectures, including CSI, that only a partial addresses are available for a short period of time before the full address to be available in certain conditions. Thus, to be conservative, all subsequent requests or responses are queued until the blocking message is unblocked and allowed to proceed. This can cause significant delays in the system as messages are held up unnecessarily. An alternative solution which only works if complete the address information is available extensive content addressable memory (CAM) matching to perform a complete match between all requests address and the address for all open responses. This solution is expensive in terms of design costs and circuit area and does not work for the processing time when only partial addresses are available.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a system of one embodiment of the invention.

FIG. 2 is a flow diagram of operation in one embodiment of the invention.

### DETAILED DESCRIPTION

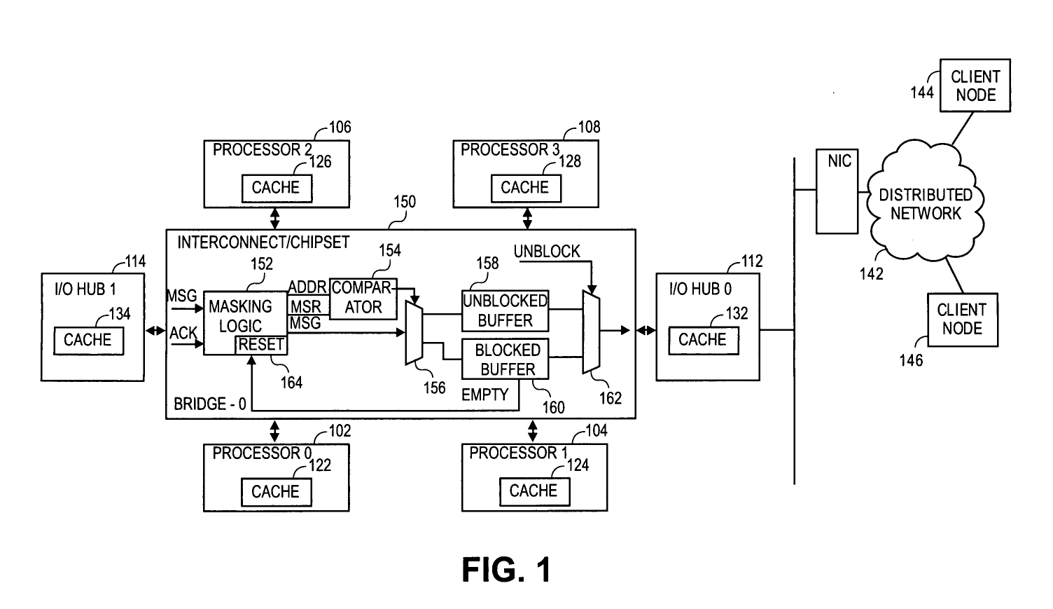

FIG. 1 is a block diagram of a system of one embodiment of the invention. A plurality of caching agents, here four processors 102, 104, 106, 108 and two input output (I/O) hubs 112, 114 share a common point-to-point interconnect 150. Each caching agent 102, 104, 106, 108, 112, 114 includes a cache 122, 124, 126 128, 132, 134 respectively among which coherency should be maintained. In one embodiment, I/O controller hub 112 may be connected to distributed network 142, such as the internet or a local area network (LAN) via a network interface card (NIC) 140. This is particularly desirable where the system is part of a server platform. However, embodiments of the invention may be used in substantially any multiprocessor system using point-to-point links with channels between coherent caching agents, including multiple socket server platforms, blade server platforms, etc. A “link” is generally defined as an information-carrying medium that establishes a communication pathway for messages, namely information placed in a predetermined format. The link may be a wired physical medium (e.g., a bus, one or more electrical wires, trace, cable, etc.) or a wireless medium (e.g., air in combination with wireless signaling technology). One or more client nodes 144, 146 may be coupled to the distributed network 142.

Interconnect 150 includes masking logic 152, which receives an incoming message (or at least an address or partial address thereof) and a blocking signal. In some embodiments, a blocking signal may be implicit, such as by discerning a type of message received and knowledge that such messages are blocking messages. For example, response forward (Rsp_Fwd) messages are common blocking messages.

As one example of a Rsp_Fwd message, there are certain cases when the cache that is snooped has a modified copy of the data. To reduce the time for the requester obtain the data and start the appropriate processing, this data is sent to the requestor directly, and this information is sent over to the home agent in the interconnect. This is used by the home agent to know that the data has already been sent to the requester. The “home agent” is broadly defined as a device that provides resources for a caching agent to access memory and, based on requests from the caching agents, can resolve conflicts, maintain ordering and the like. This Rsp_Fwd message also comes with some auxiliary information regarding the state information of the cache line. In the case there is another processor agent that requests the same cache line, the Rsp_Fwd message from the caching agent is used as reason why the other processor cannot be given the ownership of the data. That is the caching agent had already picked the next owner. The kind of control is critical for maintaining the multiple socket computer system coherency protocol correctness.

If the block signal is asserted, then masking logic 152 updates the masking parameters as described in more detail below and forwards the blocking message via routing logic 156 to the blocked buffer 160. If the blocking signal is not asserted (explicitly or implicitly), the incoming message is not a blocking message, the masking logic passes the masking parameters and whatever portion of address it has to a comparator 154. If the comparison at the comparator results in a match, the message is routed to the blocked buffer 160 by routing logic 156. Alternatively, if the comparison does not result in a match, routing logic 156 routes the message to unblocked buffer 158.

In one embodiment, blocked buffer 158 and unblocked buffer 160 may be first in first out buffers (FIFOs). It is not necessary that the FIFOs be physical FIFOs rather, the FIFOs may be logical FIFOs formed using, for example, a linked list or some other similar mechanism. Selection circuit 162 selects from which buffer processing of messages occurs. This selection is based on the receipt or nonreceipt of an unblocking signal which is dictated by the architectural state of a system. For example, the unblocking signal may be asserted in response to a receipt of a particular message at the interconnect 150. Reset logic 164 causes masking logic 152 to reset the masking parameters responsive to a signal that the blocked buffer is empty. As explained below, this avoids a state where the mask degenerates to complete blocking.

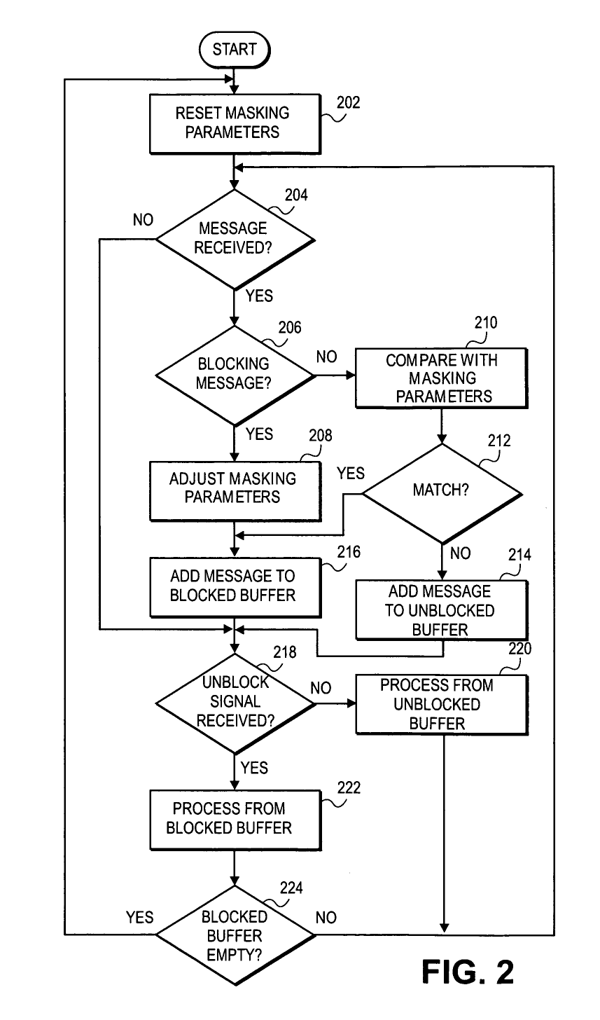

FIG. 2 is a flow diagram of operation in one embodiment of the invention. At block 202, the masking parameters are reset. In one embodiment of the invention, this involves setting an address parameter and a mask value to an indeterminent state. At block 204, a determination is made if a message has been received. If a message has been received, a determination is made at decision block 206 if the message is a blocking message. This may be determined as a result of an explicit blocking signal or implicitly, e.g., by identifying the message type as a blocking message. If the message is a blocking message, the blocking parameters are updated at block 208. In one embodiment, two blocking parameters exist: the address parameter and the mask value. The address parameter is adjusted to be a logical AND of the previous address parameter with the incoming address value. That is Address Parameter=(Address Parameter) AND (Incoming Blk Msg Address). Notably this works even with partial addresses as long as it is consistently applied. An example follows with reference to Table 1. The mask value is set to be a logical OR of the previous mask value with an XOR of the previous address value with incoming address value. That is Mask Value=Not (Mask Value Or (Incoming Address XOR Address Parameter)). The concept is to mask all bits that have the unique value in the blocking FIFO. For example, if there are two blocking messages in the blocking FIFO, one of them has the value “0” of address bit 0, and the other blocking message address bit 0 has the value “1”. Then there is no need to check the incoming message address bit 0 since there is only two possible values on the bit 0: “1” or “0”. Either of these value will cause the potential conflict. The decisive factor is those unique address bit values that do not share with each blocking message addresses in the blocking FIFO.

If the message is not a blocking message at block 206, a comparison is conducted at block 210 with the masking parameters. A determination is made at block 212 if a match has occurred. In one embodiment, a match is defined as not an XOR of the incoming address with the address parameter AND existing mask value. That is Match=not (Incoming Address XOR Address Parameter) AND Mask Value.

If there is no match, the message added to an unblocked buffer at block 214. If a match occurs, the message is added to the blocked buffer at block 216. At block 218, a determination is made if an unblocking signal has been received. If not, processing from the unblocked buffer continues. If an unblocking signal has been received, processing occurs from the blocked buffer at blocked 222. A determination is then made at block 224 if the blocked buffer is empty. If the blocked buffer is empty, then masking parameters are reset at block 202. If a blocked buffer is not empty or after processing from the unblocked buffer, there may be a further determination of a message received at block 204 and the flow continues. While the flow chart illustrates a particular flow path, it should be recognized that some elements of the flow may occur in an order other than depicted and some elements may be conducted in parallel. Such flow differences are expressly contemplated as within the scope of various embodiments of the invention.

Table 1 illustrates an example of the operation of one embodiment of the invention.

TABLE 1

| | | | | Mask | |
|---|---|---|---|---|---|
| Action | Msg Type | Incoming Addr | Addr Parameter | Value | Comments |
| Update | Blk msg | 0x00001111 | 0x00001111 | 0x11111111 | All Bits match |
| Match | Non blk | 0x00001011 | 0x00001111 | 0x11111111 | Miss |
| | msg | | | | |
| Update | Blk msg | 0x00011011 | 0x00001011 | 0x11101011 | Ignore bits 2, 4 |
| Update | Blk msg | 0x00001101 | 0x00001001 | 0x11101001 | Ignore bits 1, 2, 4 |
| Match | Non blk | 0x00010000 | 0x00001001 | 0x11101001 | Miss |
| | msg | | | | |
| Match | Non blk | 0x00001101 | 0x00001001 | 0x11101001 | Hit and Block |
| | msg | | | | |
| Match | Non blk | 0x00011111 | 0x00001001 | 0x11101001 | Hit and Block |
| | msg | | | | Note this is |
| | | | | | Unnecessary |
| | | | | | block |

The first row of Table 1 reflects an incoming blocking message of an incoming address of 00001111. Assuming this is the first blocking message received an update occurs in which address parameter is set to the value of the incoming address and a mask value is set to all 1's.

The second row represents the arrival of a nonblocking message having an address of 00001011, when the match is performed because the incoming address does not share all unmasked bits with the address parameter (all bits match requirement is determined by the mask value bits being all 1s), a miss occurs and that message is routed to an unblocked buffer.

The third row represents that another blocking message is received. This blocking message has as address of 00011011 and results in an update of the address parameter so that the address parameter now reflects an XOR of the first address from the first row and the incoming address from the third row. Thus, the new address parameter is 00001011. The mask value is updated to zero out the bits not shared by the prior address parameter and the incoming address; in this case, bit 2 and bit 4. These bits will be ignored on subsequent matches.

In the fourth row, another blocking message is received. This message has an address of 00001101 and results in an update of the address parameter to be 00001001 and similarly to the mask value becomes 11101001 meaning that on subsequent matches, bits 1, 2 and 4 will be ignored.

In the fifth row, another nonblocking message is received with an address of 000100000. This results in a miss on the match and that message will be routed to the unblocked batter.

In the sixth row, another nonblocking message is received. This one having an address of 00001101 (the same as the blocking message received in the fourth row). When the match is performed because mask value matches the address parameter in all considered bits (here bits 0 and 3), this message is deemed a hit and is routed to the blocked buffer.

Finally, in the seventh row, a nonblocking message having address 00011111 arrives. It too matches the address in all considered bits (bits 0 and 3) and is therefore sent to the blocked queue. Significantly, this is an unnecessary block. However, this slight over inclusion prevents the risk of erroneous ordering while allowing partial address values to be used in mask creation. In this manner, most messages directed to an unblocked address will be permitted to proceed, without waiting for blocked messages for other addresses to continue. However, because of the update of the address in the mask will eventually result in all messages being blocked, these parameters are reset to an indeterminate/initial state each time the blocked buffer empties.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a blocking message on an ordered channel;
creating a mask from at least a partial address of the blocking message;
comparing at least a portion of an address of a subsequently received message with the mask;
routing the message to a blocked buffer if the comparing indicates the message should be blocked; and
routing the message to an unblocked buffer if the comparing does not indicate the message should be blocked.

2. The method of claim 1 further comprising:
modifying the mask if a further blocking message is received.

3. The method of claim 1 further comprising:
processing messages in the unblocked buffer without waiting for any message in the blocked buffer to make progress; and
processing a message from the blocked buffer responsive to an unblocking signal.

4. The method of claim 3 further comprising:
resetting the mask if the blocked buffer is emptied.

5. The method of claim 3 wherein processing messages in the unblocked buffer comprises:
processing the messages in a first in first out manner.

6. The method of claim 1 wherein receiving comprises:
receiving a response forward (Rsp_Fwd) message.

7. The method of claim 1 wherein comparing comprises:
matching the address with the mask and wherein a match indicates the message should be blocked.

8. An apparatus comprising:
masking logic to create a mask from a partial address of an incoming message;
comparing logic to identifying if a subsequent message should be blocked based on the mask;
a first buffer to retain unblocked messages; and
a second buffer to retain blocked messages.

9. The apparatus of claim 8 wherein the masking logic comprises:
resetting logic to reset the mask responsive to an empty condition in the second buffer.

10. The apparatus of claim 8 wherein the first and second buffers each comprise:
a FIFO.

11. The apparatus of claim 8 where the masking logic comprises:
updating logic to update the mask responsive to receipt of additional blocking messages.

12. A system comprising:
a multiple socket server platform having a plurality of caching agents;
a point to point interconnect on the platform to provide a data path between the caching agents of the plurality; and
masking logic within the interconnect to create masking parameters from at least a portion of addresses of messages received at the interconnect.

13. The system of claim 12 further comprising:
a comparator to compare an address of an incoming message with the mask.

14. The system of claim 13 further comprising:
a first buffer;
a second buffer; and
routing logic to route messages having addresses matching the masking parameters to second buffer and message not matching the masking parameters to the first buffer.

15. The system of claim 12 further comprising:
resetting logic to reset the masking parameters when a buffer for blocked messages becomes empty.

16. The system wherein the caching agents comprises:
a plurality of processors; and
at least one input output (I/O) hub.

17. The system of claim 12 further comprising:
a network interface card coupled to the I/O hub.
